(19) United States
(12) Patent Application Publication
(10) Pub. No.: US 2013/0042272 A1
(43) Pub. Date: Feb. 14, 2013

(54) CONSUMER PURCHASES VIA MEDIA CONTENT RECEIVER

(71) Applicant: Yaroslav Miroshnychenko, Kharkiv (UA)

(72) Inventor: Yaroslav Miroshnychenko, Kharkiv (UA)

(73) Assignee: ECHOSTAR UKRAINE, L.L.C., Kharkiv (UA)

(21) Appl. No.: 13/582,037

(22) PCT Filed: Mar. 3, 2010
(86) PCT No.: PCT/UA2010/000009

§ 371 Date: Oct. 25, 2012

(51) Int. Cl. H04N 21/478; H04N 21/431

(52) U.S. Cl. 725/42; 725/60

(57) ABSTRACT

A method of facilitating purchases of products via a media content receiver is presented. In the method, the media content receiver receives media content representing a product. The receiver also receives a product code associated with the product. The media content representing the product is presented to a user. While presenting the media content, a request is received from a user. In response to receiving the request, the product code is transmitted. After transmitting the code, data descriptive of the product is received. The data is presented to the user. A product selection based on the data for the product is then received. In response to receiving the selection, an order for the product is transmitted. In another embodiment, no product codes are received at the receiver; instead, a channel identifier for a channel carrying the media content is transmitted instead of the product code.

### BACKGROUND

Among the many advantages sometimes provided by a satellite or cable television receiver, or “set-top box”, is the ability to allow a user to purchase retail products, such as items displayed for sale on a home shopping channel. Generally, a shopping channel will spend several minutes displaying and discussion a particular item, during which time the viewer may use a telephone to dial a toll-free number and order the product, if so inclined. Thus, even though the set-top box is employed to relay the product offering to the viewer, the viewer employs a separate communication device, and utilizes a separate charge account, to purchase the product.

In other cases, the purchasing of products presented to a viewer by way of a television receiver may be facilitated by way of an interactive program downloaded into the receiver. Such information may include the products and various available options, pricing, and so on. The information provided with the interactive program, or the program itself, may require periodic updating within the set-top box to reflect any availability and pricing changes that may occur, typically with little or no notice.

### BRIEF DESCRIPTION OF THE DRAWINGS

Many aspects of the present disclosure may be better understood with reference to the following drawings. The components in the drawings are not necessarily depicted to scale, as emphasis is instead placed upon clear illustration of the principles of the disclosure. Moreover, in the drawings, like reference numerals designate corresponding parts throughout the several views. Also, while several embodiments are described in connection with these drawings, the disclosure is not limited to the embodiments disclosed herein. On the contrary, the intent is to cover all alternatives, modifications, and equivalents.

FIG. 1 is a simplified block representation of a media content receiver according to an embodiment of the invention.

FIG. 2 is a flow diagram of a method according to an embodiment of the invention of facilitating product purchases via the media content receiver of FIG. 1.

FIG. 2A is a flow diagram of a method according to another embodiment of the invention of facilitating product purchases via the media content receiver of FIG. 1.

FIG. 3 is a block diagram of a satellite television system according to an embodiment of the invention, in which the system includes multiple shopping outlet systems, a satellite uplink facility, a content provider purchasing system, and multiple satellite television receivers.

FIG. 4 is a block diagram of one of the shopping outlet systems depicted in FIG. 3 according to an embodiment of the invention.

FIG. 5 is a block diagram of the satellite uplink facility of FIG. 3 according to an embodiment of the invention.

FIG. 6 is a graphical representation of communications in the satellite television system of FIG. 3 for providing media content with codes for products that may be purchased according to an embodiment of the invention.

FIG. 7 is a block diagram of the content provider purchasing system of FIG. 3 according to an embodiment of the invention.

FIG. 8 is a block diagram of one of the satellite television receivers of FIG. 3 according to an embodiment of the invention.

FIG. 9 is a graphical representation of communications in the satellite television system of FIG. 3 facilitating the purchase of a product according to an embodiment of the invention.

FIG. 9A is a graphical representation of communications in the satellite television system of FIG. 3 facilitating the purchase of a product according to another embodiment of the invention.

### DETAILED DESCRIPTION

The enclosed drawings and the following description depict specific embodiments of the invention to teach those skilled in the art how to make and use the best mode of the invention. For the purpose of teaching inventive principles, some conventional aspects have been simplified or omitted. Those skilled in the art will appreciate variations of these embodiments that fall within the scope of the invention. Those skilled in the art will also appreciate that the features described below can be combined in various ways to form multiple embodiments of the invention. As a result, the invention is not limited to the specific embodiments described below, but only by the claims and their equivalents.

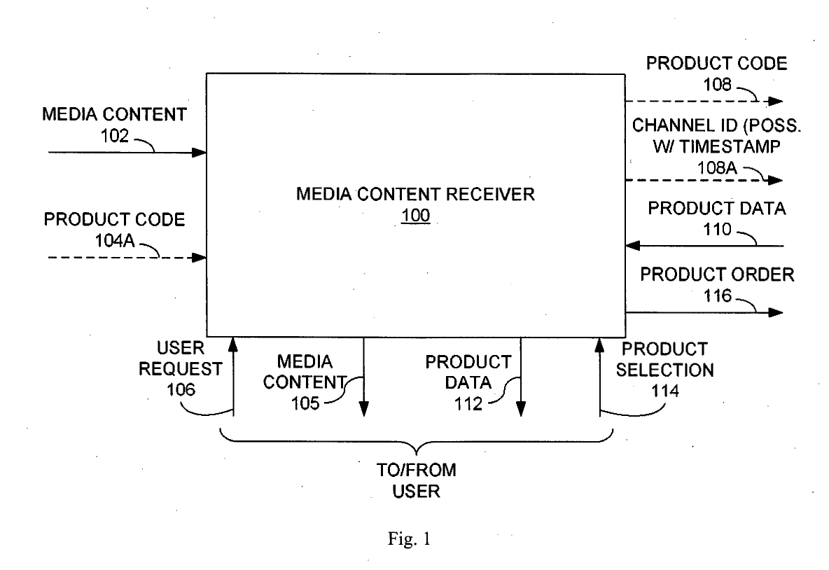

FIG. 1 depicts a media content receiver 100 according to an embodiment of the invention. In one example, the media content receiver 100 may be a satellite, cable, or terrestrial (“over-the-air”) television receiver or set-top box. In another example, the media content receiver 100 may be a television that incorporates a receiver as described in greater detail below. In another implementation, the media content receiver 100 may be a satellite, cable, or terrestrial radio. Alternately, the media content receiver 100 may be a desktop or laptop computer, mobile communication device, personal digital assistant (PDA), gaming system, or any other device configured to receive media content, such as audio and/or visual content, textual content, graphical content, and/or the like, and present such content to a user, either directly or via a separate output device.

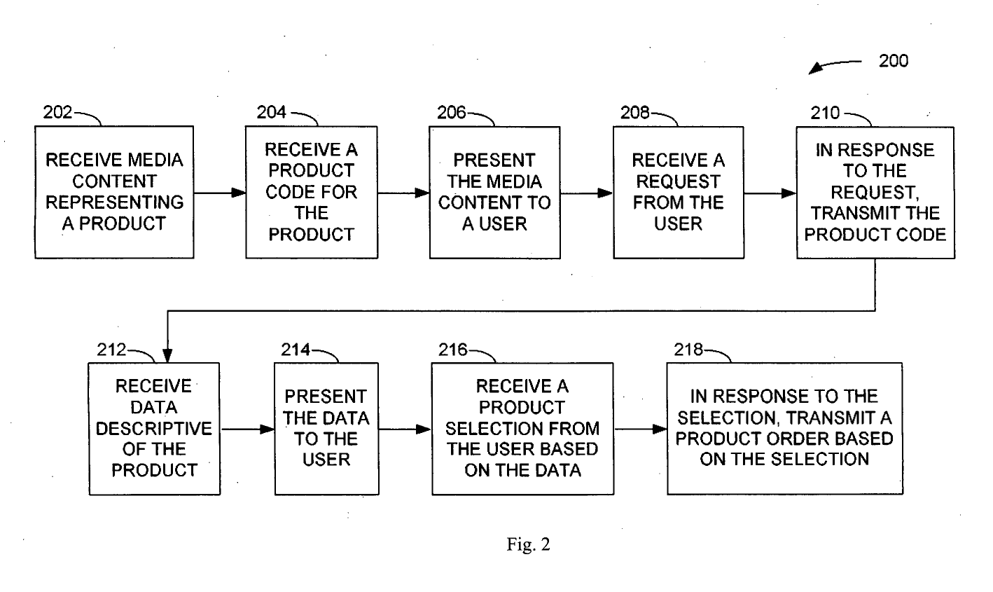

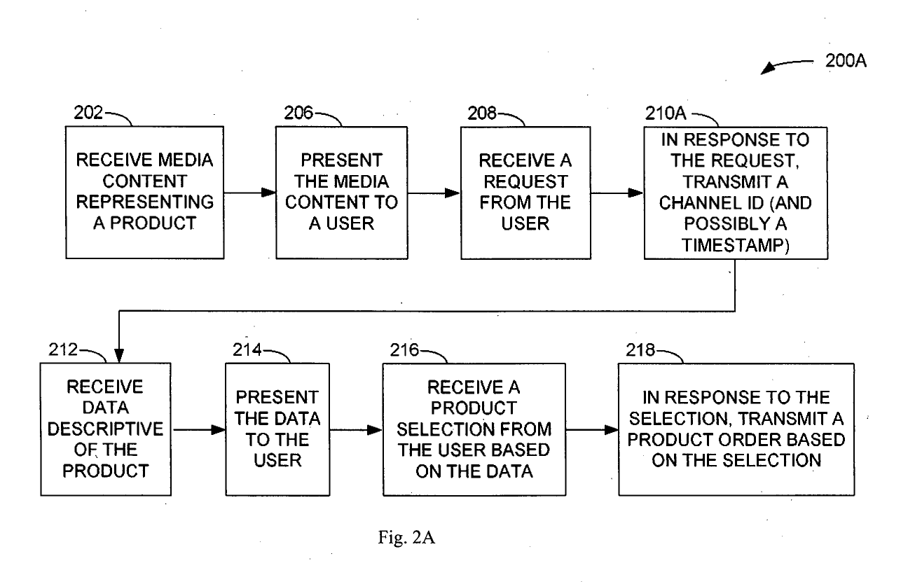

FIG. 2 presents a method 200 of facilitating the purchase of products using the media content receiver 100 of FIG. 1. In the method 200, the media content receiver 100 receives media content 102 that represents a product to be displayed to a user (operation 202). Herein, the product may be any product or service that a user or viewer of the media content receiver 100 may purchase. The media content receiver 100 also receives a product code 104 for the product being presented to the user (operation 204). While presenting the media content 102 as output content 105 to the user (operation 206), the receiver 100 receives a request 106 from the user (operation 208). In response to receiving the request 106, the media content receiver 100 transmits the product code 108 or other information indicating the received product code 104 (operation 210). Afterward, the media content receiver 100 receives data 110 descriptive of the product (operation 212). This data 110 may include, for example, various purchase options involving the product, such as size, color, quantity, and so forth. The media content receiver 100 presents the data 110 as data 112 to the user (operation 214). The receiver 100 then receives from the user a product selection 114 based on the presented data 112 (operation 216). The product selection 114 may include, for example, the particular size, color, and quantity desired. In response to receiving the product selection 114 from the user, the receiver 100 transmits a product order 116 for the product based on the user product selection 114 (operation 218).

FIG. 2A presents another method 200A of facilitating the purchase of products employing the media content receiver 100 of FIG. 1. In this particular method 200A, the media content receiver 100 receives media content 102 that represents a product to be displayed to a user (operation 202). The media content 102 may be presented on one of multiple media content channels being received at the receiver 100. However, in this embodiment, no additional data, such as a product code, is delivered or included with the media content 102. While presenting the media content 102 as output content 105 to the user (operation 206), the receiver 100 receives a request 106 from the user (operation 208). In response to receiving the request 106, the media content receiver 100 transmits a channel identifier 108A indicating the media content channel over which the media content 102 representing the product is received (operation 210A). In some embodiments, the channel identifier 108A may also be accompanied with a time value, such as a timestamp or other timing data indicating when the user request 106 was received or initiated. Afterward, as in method 200 of FIG. 2A, the media content receiver 100 receives data 110 descriptive of the product (operation 212). The media content receiver 100 presents the data 110 as data 112 to the user (operation 214). The receiver 100 then receives from the user a product selection 114 based on the presented data 112 (operation 216). In response to receiving the product selection 114 from the user, the receiver 100 transmits a product order 116 for the product based on the user product selection 114 (operation 218).

In other embodiments, a computer-readable storage medium may have encoded thereon instructions for a processor or other control circuitry of the media content receiver 100, such as a television set-top box, to implement either or both of the methods 200 and 200A.

While FIGS. 2 and 2A depict a specific order of execution for the various operations outlined therein, other orders of execution are possible, including concurrent execution of one or more operations. For example, with respect to FIG. 2, the product code 104 associated with the product may be received while the media content 102 representing the product is also being received. Also, in either of the methods 200, 200A, the presentation of the output media content 105 to the user may occur concurrently with the reception of the media content 102 so that the content 102 is being provided to the user as it is being received.

As a result of employing either of the methods 200, 200A, the user of the receiver 100 may provide a simple request 106 for more information concerning the product being currently displayed or presented by the receiver 100, thus not requiring the user to specify the particular product from a possibly length list. The receiver 100 may then retrieve more specific, updated information regarding the product in response to the request 106 so that such information for multiple products need not be stored within the receiver 100 over long periods of time. Further, the user may determine the exact product desired and initiate a purchase of the product through the receiver 100, thus simplifying the purchasing process for the user. Additional advantages may be recognized from the various implementations of the invention discussed in greater detail below.

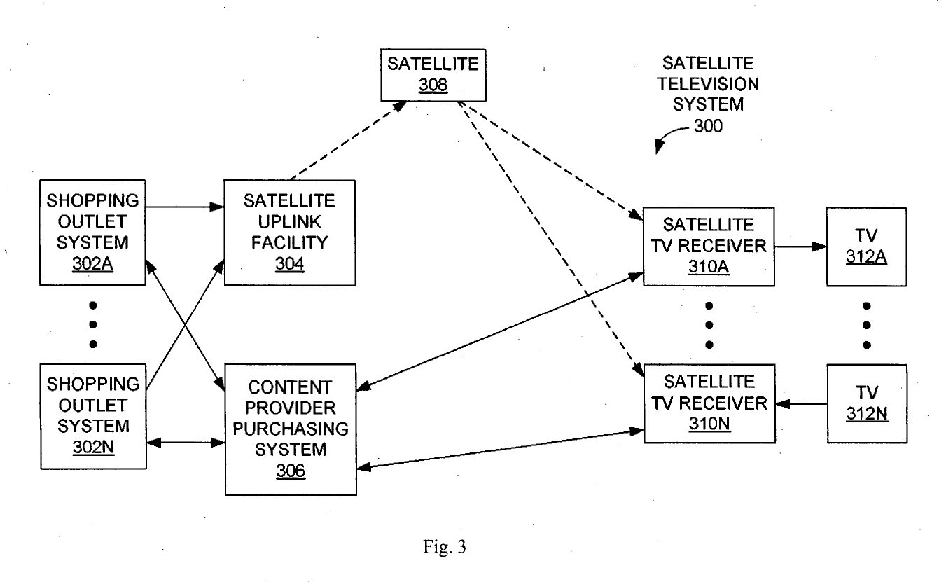

FIG. 3 is a simplified block diagram of a satellite television system 300 including multiple satellite television receivers or set-top boxes 310A-310N, each serving as a media content receiver 100 as described above in conjunction with FIG. 1. The satellite television system 300 also includes multiple shopping outlet systems 302A-302N, a satellite uplink facility 304, a content provider purchasing system 306, at least one satellite 308, and multiple televisions 312A-312N communicatively coupled with the receivers 310A-310N. Other devices, including but not limited to transmitters, receivers, repeaters, and communication switches, may also be included in the satellite television system 300, but are not illustrated in FIG. 3 to simplify the following discussion.

As with a typical satellite television system, the satellite uplink facility 304 receives programming from a number of content sources, processes and transmits the content via an uplink to the satellite 308, which, by way of its transponders, receives and retransmits the content to multiple satellite television receivers 310, each of which then relays that content to at least one television 312 for presentation to the user, such as by way of audio and/or video output. In FIG. 3, the sources providing content to the uplink facility 304 include the multiple shopping outlet systems 302, which provide content representing products and services to be offered for sale to users of the receivers 310. Each shopping outlet system 302 may be associated with a particular shopping outlet or channel, such as QVC or HSN, which is typically accessible via satellite or cable television content providers. In other examples, one or more of the shopping outlet systems 302 may be a typical television programming channel providing commercials, infomercials, and the like as part of the television content being broadcast. In some embodiments, the content may also include product codes or similar information which is ultimately received at the receivers 310.

The shopping outlet systems 302 also provide specific data regarding its products to the content provider purchasing system 306. The purchasing system 306, in turn, provides the data related to a particular product in response to a requesting receiver 310. In one embodiment, a request from the receiver 310 may include a product code identifying the product of interest, as indicated by the user of the receiver 310. In another implementation, the request from the receiver 310 includes a channel identifier, possibly along with a time value, such as a timestamp or similar information, to denote the product of interest. Upon receiving the data descriptive of the product in response to the request, the receiver 310 presents the data to the user, which then may interact with the receiver 310 to select the specific product to be ordered. The receiver 310 generates a product order, and transmits the order to the purchasing system 306, which, in turn, issues a purchase order usable by the shopping outlet system 302, including information identifying the user of the receiver 310, to the shopping outlet system 302 for order fulfillment.

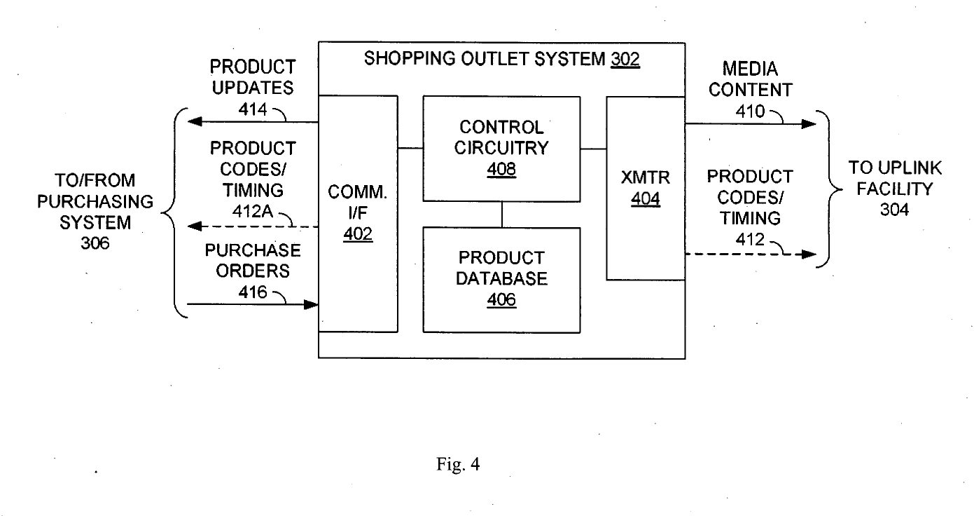

An example of one of the shopping outlet systems 302 is depicted in FIG. 4. In this example, the shopping outlet system 302 includes a communication interface 402, a transmitter 404, a product database 406, and control circuitry 408. Other components may be included in the shopping outlet system 302, but are not discussed below. In one example, the shopping outlet system 302 may be associated with a shopping television channel, as noted above, but could instead be affiliated with a typical programming channel, such as a sport or news channel, providing audio/video content that presents a product or service, including but not limited to commercials and infomercials.

The transmitter 404 of the shopping outlet system 302 is configured to transmit media content 410, such as television programming or other audio/video content, which includes or portrays products of potential interest to a viewer or consumer, to the uplink facility 304. In one embodiment, the transmitter 404 also provides product codes 412 for the products represented in the media content 410 to the uplink facility 304. Each of the product codes 412 may include a series of alphanumeric characters identifying the associated product. In one example, the shopping outlet system 302 or some other system associated therewith generates the product codes 412 that are transmitted to the uplink facility 304.

In addition, in one embodiment, each of the product codes 412 being transmitted includes timing information indicating when during the media content 410 the associated product is being presented. In another example, the shopping outlet system 302 synchronizes the transmission of the media content 410 with the transmission of the shopping codes 412 so that the timing between the codes 412 and the content 410 is represented by the timing of the transmissions.

In another embodiment, the transmitter 404 transmits neither product codes 412 nor associated timing information to the uplink facility 304. Instead, such information 412A may be transferred via the communication interface 402 to the purchasing system 306, as described in greater detail below, to correlate product requests from the user of a receiver 310 with the content being received at the receiver 310 and displayed to the user.

The transmitter 404 may be any wired or wireless transmitter configured to transfer the media content 410 and associated product codes/timing information 412 to the uplink facility 304, including those transmitters typically employed by cable and satellite networks to transmit media content to such a facility 304.

The communication interface 402 of FIG. 4 is configured to communicate with the content provider purchasing system 306 of FIG. 3. More specifically, the communication interface 402 transmits product information/updates 414 to the content provider purchasing system 306. The product information 414 may include any information descriptive of the products available through the shopping outlet, such as models, sizes, colors, number remaining in stock, and other descriptive information. The outlet system 302 may transmit product updates 414 at any time to ensure that the purchasing system 306 possesses up-to-date information regarding each of the products.

Further, the communication interface 402 may receive purchase orders 416 from the purchasing system 306. Each of the purchase orders 414 may include or indicate any information needed by the shopping outlet to fulfill an order for a product. This information may include the identity of the product to be purchased, including size, color, and any other optional characteristics of the product being procured, and the quantity of products being purchased. Each of the purchase orders 416 may also include the name, address, contact information, billing information, and/or the like of the purchaser. The purchase orders 414 may take any data structure or form, including but not limited to e-mails, file transfers, and datagrams.

As noted above, the communication interface 402 may transfer product codes 412A and associated timing information via the communication interface 402 to the purchasing system 306. More specifically, the timing information for a particular product code 412A may indicate the day and period of time during which the media content 410 representing the product indicated by the product code 412A is to be broadcast. In some implementations, a channel identifier designating the television channel or network over which the media content 410 representing the product of interest is to be presented may be included in the product code information 412A. Alternatively, the channel identifier may be inferred by the identity of the shopping outlet system 302, as the outlet system 302 may be associated with a particular broadcast channel in some environments. In some implementations, the communication interface 402 transfers the products codes, timing information, channel identifiers, and the like prior to the transmission of the media content 410 associated with the corresponding products to ensure the purchasing system 306 possesses the information prior to receiving any requests for information concerning the product from a receiver 310.

The communication interface 402 may be any wired or wireless communication interface capable of transmitting the product updates 414 and purchase orders 416 between the shopping outlet system 302 and the content provider purchasing system 306. Examples of the communication interface 402 include but are not limited to an interface to a wide-area network (WAN), such as the Internet, a public switched telephone network (PSTN), and an interface for a mobile or cellular communication network.

The product database 406 is configured as a source of the information reflected in the product updates 414 transmitted to the purchasing system 306. The information in the product database 406 may be supplied by other computing systems associated with the shopping outlet system 302, by manufacturers of the various products, or by some other information source. The product database 406 may also store the product codes 412, 412A and any associated timing or channel identification information in some implementations. The product database 406 may include one or more volatile and/or nonvolatile data storage systems, including but not limited to static and dynamic random access memory (RAM) and magnetic and optical disk memory systems.

The control circuitry 408 of the shopping outlet system 302 controls the various components of the outlet system 302 as described more fully above, including initiating the transfer and reception of information via the communication interface 402 and the transmitter 404, as well as the processing of that information. The control circuitry 408 may include one or more processors, such as a microprocessor, microcontroller, or digital signal processor (DSP), configured to execute instructions directing the processor to perform the functions mentioned herein. The control circuitry 408 may also include memory or data storage adapted to contain such instructions. Such memory may also include data to aid the control circuitry 408 in performing the tasks more discussed above. In another implementation, the control circuitry 408 may be strictly hardware-based logic, or may include a combination of hardware, firmware, and/or software elements.

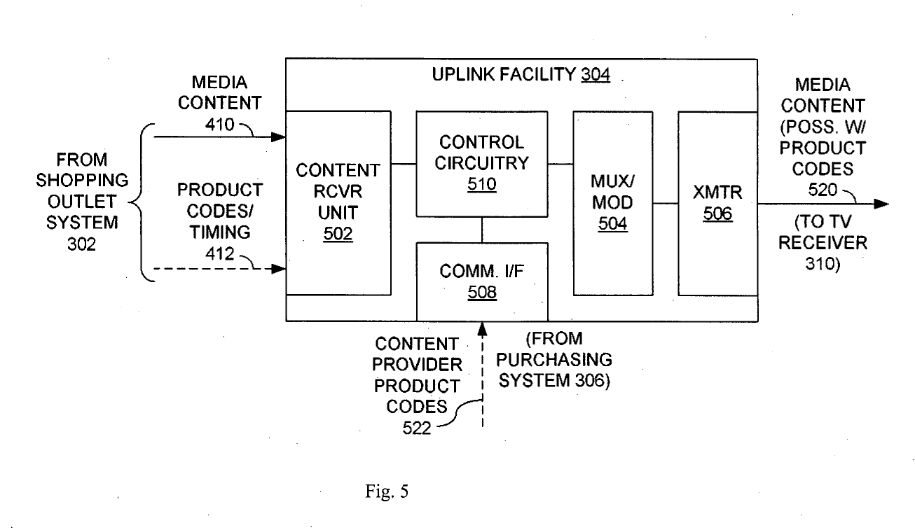

FIG. 5 is a block diagram of one example of the satellite uplink facility 304 depicted in FIG. 3. As shown, the uplink facility 304 includes a content receiver unit 502, a multiplexer/modulator unit 504, a transmitter 506, a communication interface 508, and control circuitry 510. Other components typically associated with a satellite uplink facility may be incorporated in the uplink facility 304 as illustrated in FIG. 5, but such components are not described further hereinafter.

The content receiver unit 502 is configured to receive the media content 410 and, in one embodiment, the product codes/timing information 412, from the shopping outlet system 302 over the same communication medium employed by the shopping outlet system 302 to transmit that information. Typically, the content receiver unit 502 may be any such unit typically employed to receive media content, and possibly associated metadata (such as closed captioning and subtitling information), from any media content source, such as cable or satellite networks or media outlets, including but not limited to news and sports programming networks. The uplink facility 304 may include multiple content receiver units 502 (not shown in FIG. 5), one for each shopping outlet system 302 from which the facility 304 receives the media content 410, as well as other receiver units 502 for other media content sources not specifically described herein.

In an embodiment in which the uplink facility receives the product codes 412 and associated timing data, the multiplexer/modulator 504 is configured to receive the media content 410 and the product codes 412 after being processed via the control circuitry 510, and multiplex the content 410 and codes 412 with content from other receiver units 502 of the uplink facility 304 to generate one or more content streams. These streams form a combined media content 520 that incorporates the media content 410 from the shopping outlet system 302 combined with the product codes 412 serving as metadata for the content 410.

In an implementation in which the uplink facility 304 does not receive the product codes and corresponding timing information, the multiplexer/modulator 504 is configured to receive the media content 410 and multiplex the content 410 with content from other receiver units 502 to generate one or more content streams.

In either scenario, the multiplexer/modulator 504 them modulates the media content streams according to a format acceptable to the satellite 308 and the television receivers 310 of FIG. 3. One example of such a format is the format provided in the Digital Video Broadcasting-Satellite (DVB-S) standard.

The modulated content streams are then forwarded to the transmitter 506 for transmission via satellite dish antenna or similar means to the satellite 308, which is configured to receive, amplify, and retransmit the media content streams to the multiple satellite television receivers 310 below.

In one embodiment, the uplink facility 304 includes a communication interface 508 configured to receive content provider product codes 522 from the content provider purchasing system 306, which may be specifically requested by the control circuitry 510 of the uplink facility 304 on a per-product basis. The communication interface 508 may be any interface capable of receiving the content provider product codes 522, such as an interface to the Internet, a PSTN, or a cellular or mobile communication network.

The control circuitry 510 of the uplink facility 304 communicates with, and controls, the various components of the facility 304, as described above. As with the control circuitry 408 of the shopping outlet system 302 discussed earlier, the control circuitry 510 of the uplink facility 304 may include one or more processors configured to execute instructions stored in a digital storage medium to direct the processor to perform the functions mentioned herein. In another implementation, the control circuitry 510 may be strictly hardware-based logic, or may include a combination of hardware, firmware, and/or software elements.

As indicated by the name, the content provider product codes 522 may differ from the product codes 412 received from the outlet shopping system 302. In one example, the control circuitry 510 requests a corresponding content provider product code 522 from the purchasing system 306 for each of the product codes 412 received from the shopping outlet system 302 to replace the outlet product code 412 with the associated content provider product code 522. Presumably, each of the content provider product codes 522 adheres to some format defined by the content provider to provide a unique product code 522 for each product, regardless of the shopping outlet or manufacturer providing the product. This uniqueness thus protects against any potential misunderstanding between the user and the shopping outlet regarding the identity of the product to be ordered.

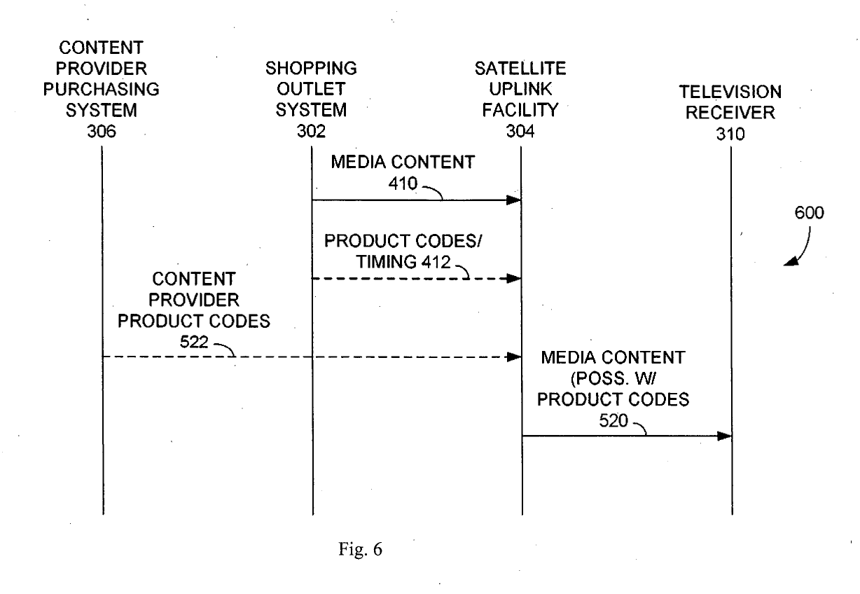

FIG. 6 is a graphical representation of one embodiment of the communication between the satellite uplink facility 304 and other portions of the satellite television content system 300 to incorporate product codes within the media content 520 being transferred to the television receivers 310. Upon receiving the media content 410 and the associated product codes and timing information 412, the control circuitry 510 may request and receive a content provider product code 522 for each outlet product code 512 received. The control circuitry 510 then inserts each content provider product code 522 into the media content 410 as metadata according to the timing information accompanying the outlet system product codes 412. Thus, when received at the television receivers 310, the product codes 522 incorporated in the transmitted media content 520 will be synchronized with the presentation of their associated products in the content 520. In another implementation, the original shopping outlet codes 412 may be incorporated into the transmitted media content 520, thus negating any requirement for requesting the content provider content codes 522 from the purchasing system 306.

In another implementation, the product codes 412 received from the outlet shopping system 302 may be guaranteed to be unique compared to product codes 412 generated by other outlet shopping systems 302. For example, the original product codes 412 may be Global Trade Item Numbers (GTINs) or some other type of globally-unique product identifier. As a result, the control circuitry 510 may insert the product codes 412 received from the shopping outlet system 302 directly into the transmitted media content 520, and need not request and receive any content provider product codes 522 as a result.

In yet another example, no product codes are included in the media content 520 transferred to the receiver 310, as the content provider purchasing system 306 may ascertain the product of interest from channel and/or time value information provided by the receiver 310, as is discussed more completely below.

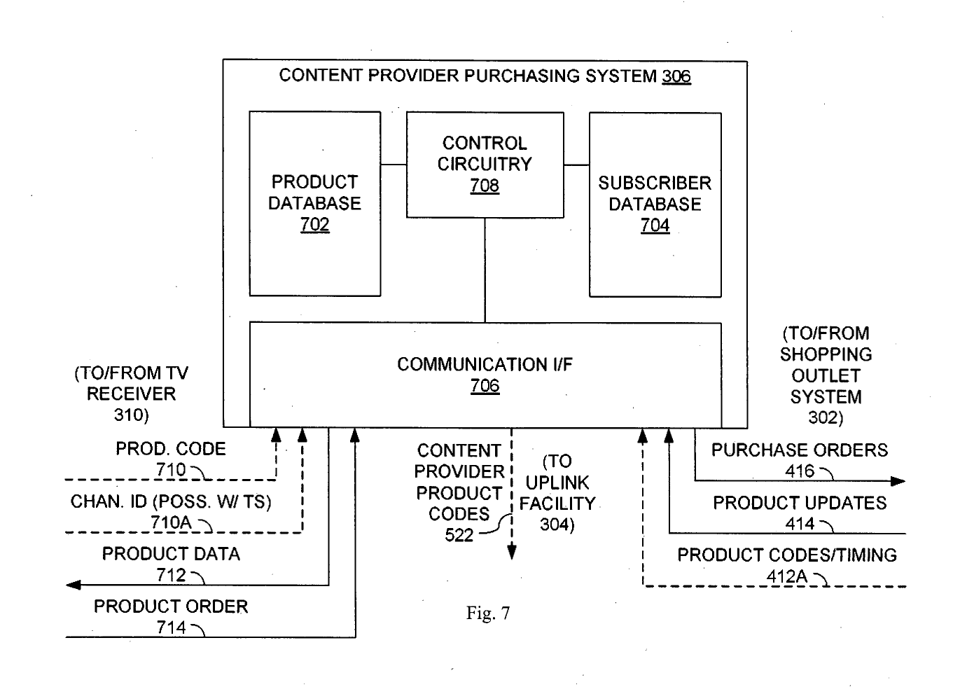

FIG. 7 is a block diagram of an example of the content provider purchasing system 306 according to one embodiment. The purchasing system 306 includes a product database 702, a subscriber database 704, a communication interface 706, and control circuitry 708. Other components possibly included in the purchasing system 306 are not depicted in FIG. 7 to simplify the following discussion.

The communication interface 706 is configured to send and transmit information, as is described in greater detail below, between the purchasing system 306 and each of the shopping outlet systems 302, the uplink facility 304, and the television receivers 310. In one example, the communication interface 706 may be any wired or wireless interface capable of transmitting and receiving the information noted below, including but not limited to the Internet or other WAN. In some examples, the communication interface 706 may include two or more separate communication connections coupled to the same type of communication network, or to different types of communication networks. The utility of such a configuration may depend on the nature of the communication with the shopping outlet systems 302, the uplink facility 304, and the receivers 310, such as the type and volume of data involved, the number of outlet systems 302 and receivers 310 being communicated with, and other factors.

The product database 702 is configured to store the product information/updates 414 received from the shopping outlet system 302 via the communication interface 706, as described above. This product database 702 becomes the source of the product data 712 discussed below. Thus, the product database 702 provides information regarding the various options, such as color, size, model, and the like, that a user may select for a particular product, as well as the code 412 for the product. In one implementation, the product database 702 may also include one or more tables or other data structures that associate each of the outlet-generated product codes 412 with a content provider product code 522, which may be transmitted upon request via the communication interface 706 to the uplink facility 304, as described above. In other examples in which the product codes 412 received at the purchasing system 306 are unique, the communication interface 706 need not transfer any content provider product codes 522 to the uplink facility 304, thus essentially eliminating any need for the purchasing system 306 and the uplink facility 304 to communicate directly with each other. In one embodiment, the product database 702 may further include product codes 412A and associated timing and/or channel information received from the outlet system 302 via the communication interface 706 in order to correlate information received from a receiver 310 with a specific product of interest.

The subscriber database 704 includes data identifying and otherwise describing each subscriber of the receivers 310 that may purchase products via the satellite television system 300. Examples of information included in the subscriber database 704 may include but are not limited to the subscriber name, content provider account number, shipping address, billing address, and credit card information. As described above, at least some of the information in the subscriber database 704 for a particular subscriber may be transmitted as part of a purchase order 416 via the communication interface 706 to the shopping outlet system 302.

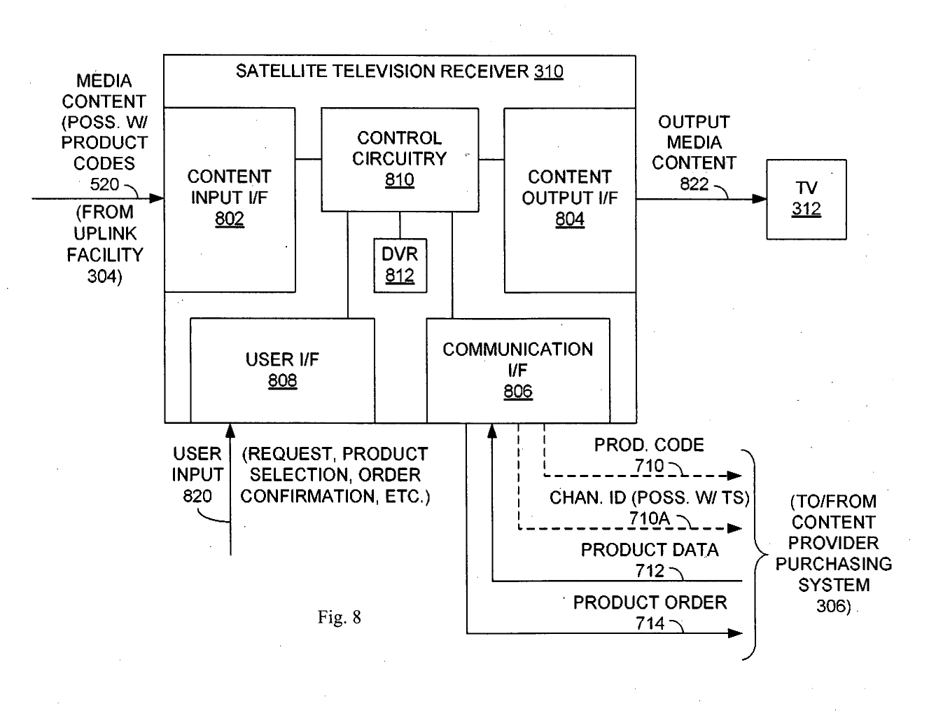

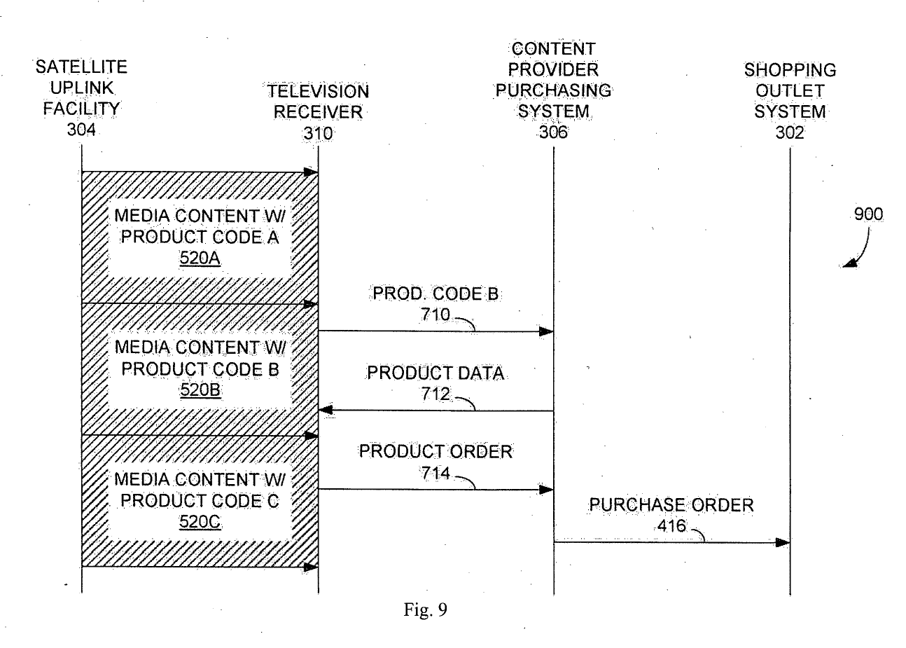

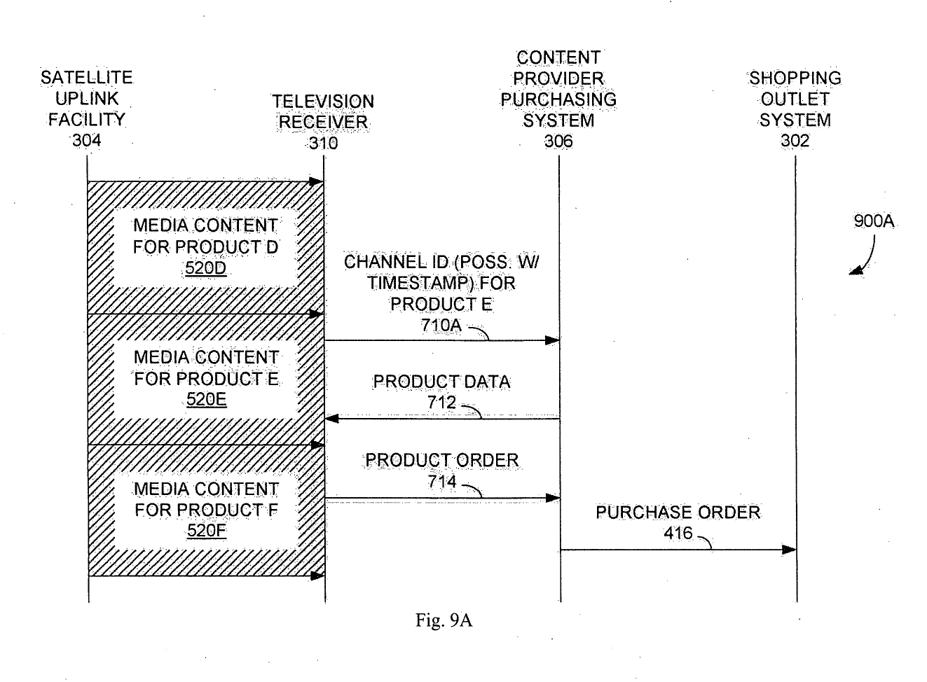

The control circuitry 708 is configured to access and control the product database 702, the subscriber database 704, and the communication interface 706 to perform the tasks described above. Further, the control circuitry 708 interacts with each receiver 310 that indicates a product purchase is being requested. This process is described in greater detail with respect to FIGS. 8 and 9. As with the systems 302, 304 described above, the control circuitry 708 may include one or more processors adapted to execute instructions stored in a digital storage medium to direct the processor to perform the functions mentioned herein. Alternatively, the control circuitry 708 may be hardware-based logic or a combination of hardware, firmware, and/or software elements.

An example of one of the satellite television receivers or set-top boxes 310 is presented in the block diagram of FIG. 8. In this example, the receiver 310 includes a content input interface 802, a content output interface 804, a communication interface 806, a user interface 808, and control circuitry 810. Optionally, the receiver 310 may include a digital video recorder (DVR) unit 812. Other components or subassemblies normally associated with a satellite television receiver, such as a power supply and a “smart card” interface, may be included in the receiver 310 of FIG. 8, but are not discussed further below. In addition, the functionality of the receiver 310 described hereinafter may be incorporated within a television or other display device in other implementations.

The content input interface 802 is configured to receive the media content 520, which may include product codes in one implementation. More specifically, the content input interface 802 may receive the media content 520 via a parabolic antenna and a low-noise block-converter (LNB) (not illustrated in FIG. 8), which receives, down-converts, and forwards the signal to the content input interface 802, typically via a coaxial cable. The content input interface 802 may include one or more tuners allowing the user to select particular programming channels of the incoming content for forwarding to the television 312, as well as an audio receiver or other entertainment system components. The content input interface 802 may also perform any decryption, decoding, and similar processing of the received content 520 required to place the content 520 in a format usable by the content output interface 804. In one example, such a format may be one of the Motion Picture Experts Group (MPEG) formats, such as MPEG-2 or MPEG-4, although other television content format standards may be utilized in other embodiments.

In another example, if the set-top box 310 is configured as a cable television set-top box for a cable television system, the content input interface 802 may be configured to receive television programming from a cable head-end. In yet another communication environment, if the set-top box 310 is a terrestrial television receiver, the content input interface 802 may receive the media content 520 via a terrestrial antenna receiving television signals “over the air”.

The content output interface 804 provides the selected and processed input media content 520 as output television content 822 to the television 312. To that end, the content output interface 804 may encode the selected television content in accordance with one or more television output formats. For example, the content output interface 804 may format the content for one or more of a composite or component video connection with associated audio connection, a modulated radio frequency (RF) connection, a High-Definition Multimedia Interface (HDMI) connection, or any other format compatible with the television 312.

Continuing with FIG. 8, the communication interface 806 is configured to communicate with the content provider purchasing system 306 via a process explained in greater detail below with respect to FIGS. 9 and 9A. The communication interface 806 may employ any of a number of communication technologies, including both wired and wireless varieties, to receive the product data 712 from the purchasing system 306, as well as to deliver requests 710 for the data 712, and to transfer product orders 714 to the purchasing system 306. For example, the communication interface 806 may be an Ethernet, Wi-Fi, Bluetooth®, or HomePlug® interface to a telephone line, or to a cable or Digital Subscriber Line (DSL) gateway for accessing the Internet or another WAN.

To allow a user of the receiver 310 to control the selection of the input media content 520, as well as perform operations regarding the purchasing of products, the user interface 808 may facilitate the entry of commands by way of user input 820. In many examples, the user interface 808 may be a remote control interface configured to receive such input 820 by way of infrared (IR), radio frequency (RF), acoustic, or other wireless signal technologies. To facilitate such information entry, the set-top box 310 may provide a menu system presented to the user via the television 312. In some implementations, the user interface 808 may also include any of a keyboard, mouse, and/or other user input device.

The control circuitry 810 is configured to control and/or access other components of the receiver 310, including, but not limited to, the content input interface 802, the content output interface 804, the communication interface 806, and the user interface 808. The control circuitry 810 may include one or more processors, such as a microprocessor, microcontroller, or DSP, configured to execute instructions directing the processor to perform the functions discussed more fully hereinafter with respect to FIG. 9. In another implementation, the control circuitry 810 may be completely hardware-based logic, or may include a combination of hardware, firmware, and/or software elements.

Optionally, the receiver 310 may include the DVR unit 812 of FIG. 8, wherein, under the control of the user via the user interface 808, selected media content received via the content input interface 802 may be stored for subsequent viewing by the user via the content output interface 804 and the connected television 312.

FIG. 9 is a graphical representation of communications among the television receiver 310, the uplink facility 304, the purchasing system 306, and the shopping outlet system 302 according to a particular embodiment in which the receiver 310 receives product codes 412 along with the media content 520. In one particular scenario, the uplink facility 302 is transmitting the media content 520 sourced by a particular shopping outlet system 302, as well as media content from other sources, via the satellite 308 to multiple receivers 310. As shown, three different programs or program segments of the media content 520 are transmitted: a first set of content 520A associated with a product code A for a first product, followed by a second set of content 520B presenting a second product associated with a second product code B, followed by a section of content 520C presenting a third product having a third product code C. In one example, the uplink facility 304 delivers the associated product code A, B, C multiple times during its media content segment 520A, 520B, 520C to ensure that the receiver 310 has received the appropriate product code A, B, C in nearly all circumstances, such as when a viewer changes the current viewing channel to the shopping channel being sourced by the shopping outlet system 302 in the middle of a media content program or segment 520A, 520B, 520C. As indicated earlier, the media content 520A, 520B, 520C may also be a commercial, infomercial, or some portion of a program on a typical television programming channel.

Presuming the user of the receiver 310 is interested in possibly purchasing the product being presented in the second media content 520B, the user indicates that interest by way of the user interface 808, such as by way of a special “purchase” or “buy” button of a remote control device. In other examples, another button of the remote control device, a combination of key presses of the remote control device, or a purchase selection on a menu presented by the receiver 310 on the television 312, may be utilized by the viewer in other embodiments to indicate the desire to purchase the product or service.

In one implementation, more than one product may be presented in a single media content portion 520, thus resulting in multiple product codes possibly being active at a single time. If the viewer is interested in one of the products, a press of a “purchase” button on the remote control device may result in the control circuitry 810 of the receiver 310 presenting or listing the products via a menu on the television 312. The viewer may then select one of the products listed via the remote control device to specify the product in which the viewer is interested.

In response to the actions of the user, the control circuitry 810 of the receiver 310 transmits the product code B 710 associated with the product of interest via the communication interface 806 to the content provider purchasing system 306. In response to the product code B 710, the control circuitry 708 of the purchasing system 306 may use the product code B 710 to retrieve product data 712 that is descriptive of the product of interest from the product database 702, and transfer the product data 712 via the communication interface 706 to the television receiver 310. As indicated above, the product data 712 may be any information describing the product, as well as providing the ordering options, such as color, size, model, quantity available, and the like, for the product.

After receiving the product data 712, the control circuitry 810 of the receiver 310 presents the product data 712, or some portion thereof, to the viewer. Typically, the control circuitry 810 may perform this task by displaying the information in a textual and/or graphical format via the content output interface 804 and the television 312, with selection buttons or similar graphical elements allowing the viewer to choose the options of interest via a remote control device in communication with the user interface 808. Once the user makes the necessary selections to order the product, the user may then use the remote control device to activate a “purchase” menu item, selection area, or some other graphical structure to indicate that the user has finished his selections and wishes to order the product. Additionally, the control circuitry 810 may provide an additional pop-up screen or similar construct asking the viewer to confirm the product purchase. An affirmative response from the viewer may then indicate to the control circuitry 810 that ordering of the product is to proceed.

The viewer may also be provided with a selection on the screen to reject all options and not purchase the product. In another example, the viewer may indicate a lack of interest in the product by a specific button on the remote control device, such as an “exit” button.

Presuming the viewer of the receiver 310 has indicated via the user interface 808 that the product is to be ordered, the control circuitry 810 generates a product order 714 listing the various options, including the quantity to be purchased, as selected by the viewer via the user interface 808. The control circuitry 810 then transfers the product order 714 via the communication interface 806 to the content provider purchasing system 306. In response to receiving the product order 714, the control circuitry 708 of the purchasing system 306 retrieves from the subscriber database 704 data associated with the subscriber of the receiver 310, such as any of the name, shipping address, billing address, subscriber account number, credit card number, and so on. This subscriber-specific data may then be coupled with the data residing in the product order 714 to generate a purchase order 416. The control circuitry 708 of the purchasing system 306 may then transmit the purchase order 416 via the communication interface 706 of the purchasing system 306 to the shopping outlet system 302.

Upon reception of the purchase order 416, the shopping outlet system 302, or another system coupled therewith, may process the order 416 and deliver the product to the subscriber according to the shipping information provided in the order 416. Further, a system associated with the shopping outlet system 302 may bill the subscriber directly, such as by way of a credit card number, or via the content provider account of the subscriber.

While the operation of the television receiver 310 as described above may involve the media content 520 and associated product codes as they are received from the uplink facility 304, the same functionality may be provided if the user is viewing the content 520 from the DVR unit 812 after being stored therein via the content input interface 802. Further, the user may employ various DVR “trick modes” (e.g., pause, rewind, fast forward, and so on) to review one or more products in the stored media presentation, and initiate a request for potentially purchasing the product, just as though the content 520 were being viewed live. Similarly, the selection of options and the ordering of the product would proceed as discussed more fully above.

Another embodiment, in which the receiver 310 receives no products codes or other metadata associated with the product being presented in the media content 520, is illustrated in the communication diagram of FIG. 9A. In this case, The receiver 310 receives from the uplink facility 304 media content 520D for a product D media content 520E representing a product E, and media content 520F for a product F. Similar to the situation described above in FIG. 9, the user may employ the user interface 808 to request more information regarding product E. In response, the control circuitry 810 indicates the current broadcast channel the user is watching by sending a channel identifier 710A via the communication interface 806 to the purchasing system 306. Presuming the user is watching that channel “live” (i.e., without any time-shifting), the purchasing system 306 may not require any additional information by presuming that the product of interest is the current product (i.e., product E) being represented in the media content 520E presently being provided to the receiver 310. As a result, the purchasing system 306 may compare the channel identifier 710A and the current time with the product codes/timing information 412A previously received from the outlet system 302 to determine the product of interest.

In another example, the purchasing system 306 may not presume that the channel identifier 710A is associated with the media content 520E for the product E currently being broadcasted by the uplink facility 304. For example, the user may be employing the DVR unit 812 of the receiver 310 to view media content 520D associated with product D, which is not currently being broadcast. In that case, the control circuitry 810 may be configured to transmit the channel identifier 710A, along with a time value, such as a timestamp or similar indication of time during which the media content 520D was originally received at the receiver 310 at substantially the time the user indicated an interest in the product. In one example, the time value may be derived from timing information generated by the control circuitry 810 as the media content 520D is being received, may be included in the media content 520D as transmitted to the receiver 310, or may be provided by some other means. Further, the time value may an indication of some point in time with any useful resolution, such as a particular frame number, a particular fraction or whole second, or some other level or resolution. Thus, when the user indicates an interest in the product D via the user interface 808 while viewing the media content 520D, the control circuitry 810 can utilize the time value of the content 520D at the point in the presentation that the user indicates interest as the timing value to be transferred to the purchasing system 306.

Continuing with FIG. 9A, once the channel identifier 710A and any related timing information is received at the purchasing system 306, the purchasing system 306 may determine the product of interest based on that information and the previously received product codes/timing information 412A, and transmit the corresponding product data 712 to the receiver 310, as described above with respect to FIG. 9. Thereafter, the receiver 310 and the purchasing system 306 operate as depicted in FIG. 9 with respect to the generation, transmission, and reception of the product data 712, the product order 714, and the purchase order 416 associated with the product of interest.

At least some embodiments as described herein thus facilitate subscriber or viewer purchases of products presented or advertised in media content, such as television programming, via the device receiving the content. Generally, the media content representing a product includes a product code or similar identifier for the product. Upon the user indicating an interest in purchasing a product via the receiver, more specific information regarding the product may be received from a content provider system communicatively coupled with the receiver. As a result, only the product codes need be downloaded via the media content path, thus limiting the amount of media content overhead consumed. In yet another embodiment, even the product codes are not required to accompany the media content, thus simplifying the transmission of the media content to the receiver. More specific information is then provided to the receiver only upon request, thus limiting the amount of communication bandwidth and data storage resources in each of the receivers that are consumed by the shopping function. Additionally, by employing a content provider purchasing system, a single product database may be updated as necessary by multiple shopping outlet systems, thus simplifying the updating of product information. Moreover, by employing a content receiver to facilitate viewer purchases, a telephone or similar audio communication device is not required to order a product, thus allowing those subscribers with hearing or speaking challenges the same product access enjoyed by others.

While several embodiments of the invention have been discussed herein, other implementations encompassed by the scope of the invention are possible. For example, while various embodiments have been described largely within the context of a satellite television set-top box, other electronic devices, such as cable and terrestrial set-top boxes, satellite and terrestrial radio receivers, televisions, Digital Versatile Disk (DVD) players, video cassette recorders (VCRs), DVRs, audio receivers, mobile communication devices, PDAs, gaming systems, and the like, may incorporate various aspects of the functionality described above to similar effect. In addition, aspects of one embodiment disclosed herein may be combined with those of alternative embodiments to create further implementations of the present invention. Therefore, while the present invention has been described in the context of specific embodiments, such descriptions are provided for illustration and not limitation. Accordingly, the proper scope of the present invention is delimited only by the following claims and their equivalents.

What is claimed is:

1. A method of facilitating purchases of products via a media content receiver, the method comprising:
receiving media content representing a product;
receiving a product code associated with the product;
presenting the media content representing the product to a user;
while presenting the media content representing the product, receiving a request from the user;
in response to receiving the request, transmitting the product code;
after transmitting the product code, receiving data descriptive of the product;
presenting the data descriptive of the product to the user;
receiving a product selection for the product from the user based on the data descriptive of the product; and
in response to receiving the product selection, transmitting an order for the product.

2. The method of claim 1, wherein:
receiving the product code occurs while receiving the media content representing the product.

3. The method of claim 1, wherein:
the media content comprises one of a television program, a commercial, and an infomercial offering the product for sale.

4. The method of claim 1, wherein:
the data descriptive of the product comprises a plurality of selectable options for purchasing the product; and
the product selection comprises at least one of the plurality of selected options selected by the user.

5. The method of claim 4, wherein:
the plurality of selectable options comprises at least one of a color, a size, a quantity, and a model of the product.

6. A media content receiver, comprising:
a content input interface configured to receive at least one of multiple channels of media content;
a content output interface configured to present the media content to a user;
a communication interface;
a user interface; and
control circuitry configured to:
receive, via the content input interface, a media presentation of a product over one of the channels of media content;
present, via the content output interface, the media presentation to a user;
transmit a channel identifier of the one of the channels via the communication interface if a request is received from the user via the user interface during the media presentation;
after transmitting the channel identifier, receive data describing the product via the communication interface;
present, via the content output interface, the data describing the product for display to the user;
receive, via the user interface, a product selection from the user based on the data descriptive of the product; and
in response to receiving the product selection, transmit, via the communication interface, an order for the product based on the product selection.

7. The media content receiver of claim 6, wherein the control circuitry is configured to:
transmit, via the communication interface, a time value indicating a time at which the request is received from the user relative to the media presentation as presented to the user.

8. The media content receiver of claim 6, further comprising:
a digital video recorder unit configured to store the media content received via the content input interface;
wherein the control circuitry is configured to store the media presentation via the digital video recorder unit for subsequent presentation to the user via the content output interface.

9. The media content receiver of claim 6, wherein:
the user interface comprises a remote control interface; and
the request comprises a remote control command to display ordering options for the product in the media presentation;
the data descriptive of the product comprise the ordering options; and
the product selection comprises a remote control command to select at least one of the ordering options.

10. The media content receiver of claim 9, wherein:
the content output interface comprises a television output interface; and
to present the data describing the product, the control circuitry is configured to provide a user-selectable menu presenting the ordering options to the user via a television coupled with the television output interface.

11. A shopping outlet system, comprising:
a product database comprising a product code for each of a plurality of products, and data descriptive of each of the plurality of products;
a transmitter configured to transmit media content representative of the plurality of products;
a communication interface configured to receive orders for the plurality of products based on the product codes and the data descriptive of the products; and
control circuitry configured to:
retrieve the product codes and the data descriptive of the plurality of products from the product database;
transmit the product codes and the data descriptive of the plurality of products via the communication interface;
generate timing information indicating when each of the products is to be presented in the media content;
transfer each of the product codes, the timing information, and the media content to the transmitter for transmission; and
process the orders received via the communication interface.

12. The shopping outlet system of claim 11, wherein:
the control circuitry is configured to transfer the product codes and the timing information with the media content as metadata of the media content.

13. The shopping outlet system of claim 11, wherein:
the media content comprises at least one television program of a shopping broadcast channel.

14. The shopping outlet system of claim 11, wherein:
the media content comprises at least one commercial message.

15. The shopping outlet system of claim 11, wherein:
the communication interface comprises an Internet Protocol interface; and
at least one of the orders is received via the communication interface as one of an e-mail message, a file transfer, and a datagram.

16. A media content provider purchasing system, comprising:
a product database comprising a channel identifier and timing information for each of a plurality of products, and data descriptive of each of the plurality of products, wherein the channel identifier indicates a media content channel over which the associated product is presented, and the timing information indicates a period of time during which the associated product is presented;
a subscriber database comprising data associated with each of a plurality of media content subscribers;
a communication interface configured to communicate with a purchase fulfillment system and a plurality of media content receivers, wherein each of the media content receivers is associated with at least one of the media content subscribers; and
control circuitry configured to:
receive a channel identifier from one of the media content receivers via the communication interface;
in response to receiving the channel identifier, transmit the data descriptive of the product associated with the received channel identifier and a current time value via the communication interface to the requesting media content receiver;
receive a selection for the product associated with the received product code from the requesting media content receiver via the communication interface, wherein the selection is based on the transmitted data descriptive of the product associated with the received product code; and
transmit an order via the communication interface to a shopping outlet system, wherein the order includes data indicating the received selection, and information from the subscriber database associated with the media content subscriber of the requesting media content receiver.

17. The media content provider purchasing system of claim 16, wherein the control circuitry is configured to:
receive a time value from the one of the media content receivers via the communication interface, wherein the times value comprises the current time value.

18. The media content provider purchasing system of claim 16, wherein the control circuitry is configured to:
receive, from the shopping outlet system via the communication interface, the channel identifier and the timing information for each of the plurality of products, and the data descriptive of each of the plurality of products; and
store the channel identifier and the timing information for each of the plurality of products, and the data descriptive of each of the plurality of products, in the product database.

19. The media content provider purchasing system of claim 18, wherein:
the channel identifier and the timing information for each of the plurality of products, and the data descriptive of each of the plurality of products, are received and stored prior to receiving the channel indicator from the one of the media content receivers.

20. The media content provider purchasing system of claim 16, wherein:
the information from the subscriber database comprises at least one of a name and a shipping address of the media content subscriber of the requesting media content receiver.
